(19) United States
(12) Patent Application Publication
(10) Pub. No.: US 2025/0140077 A1
(43) Pub. Date: May 1, 2025

(54) VERIFIABLE RANDOM LOTTERY METHOD BASED ON MERKLE TREE AND SORTING MANNER

(71) Applicant: HANGZHOU DIANZI UNIVERSITY, Hangzhou City (CN)

(72) Inventors: Gengran HU, Hangzhou City (CN); Zupei NIE, Hangzhou City (CN); Lin You, Hangzhou City (CN)

(73) Assignee: HANGZHOU DIANZI UNIVERSITY, Hangzhou City (CN)

(21) Appl. No.: 18/761,852

(22) Filed: Jul. 2, 2024

(30) Foreign Application Priority Data
Oct. 27, 2023 (CN) 202311405787.5

(51) Int. Cl. G07F 17/32; G06F 7/08; G06Q 50/34

(52) U.S. Cl. CPC G07F 17/329; G06F 7/08; G06Q 50/34; G07F 17/3241

(57) ABSTRACT

Provided is a verifiable random lottery method based on a Merkle tree and a sorting manner, including: determining a number of winners and participants in a lottery, and allowing a lottery system to record personal data submitted by each of the participants and a random timestamp clicked and confirmed by the participant in a time period; constructing a Merkle tree with an SM3 algorithm, and taking a root of the Merkle tree as a random seed; taking the random seed as an input, iteratively running the SM3 algorithm to obtain a random string of each participant, sorting all of the random strings in a descending manner, and selecting the winners in the lottery; verifying the random seed in the lottery; and verifying a lottery result: iteratively running the SM3 algorithm on a legal random seed to reproduce and verify the lottery result.

### CROSS REFERENCE TO RELATED APPLICATION

This patent application claims the benefit and priority of Chinese Patent Application No. 202311405787.5, filed with the China National Intellectual Property Administration on Oct. 27, 2023, the disclosure of which is incorporated by reference herein in its entirety as part of the present application.

### TECHNICAL FIELD

The present disclosure belongs to the field of random algorithms, and relates to a verifiable random lottery method based on a Merkle tree and a sorting manner.

### BACKGROUND

For the sake of fairer distribution of market resources, lottery operations are increasingly used in house purchasing, car purchasing, school-age children enrollment and other scenarios in big cities. Nowadays, the large-scale lottery operations are mainly divided into two types. According to the first type of lottery operations, a random seed is generated with a random lottery ball, and then a random index is generated by invoking a classical random number algorithm (such as a rand function) to obtain a lottery result, for example, the lottery operations on house-purchasing qualification in Beijing. According to the second type of lottery operations, a random index is generated by directly invoking a classical random number algorithm on a computer to obtain a lottery result, and a random seed is generated by an entropy pool of an operation system, for example the lottery operations on house-purchasing qualification in Hangzhou. However, the two types of operations have the following defects:
1. The random seed cannot be reproduced. For the first type, the single process realized by the lottery ball cannot be reproduced. For the second type, entropy sources in the entropy pool of the operation system are various uncertain device events, and also cannot be reproduced.
2. The random seed is not associated with user data. Regardless of the lottery ball or the entropy pool of the operation system, the random seed is not associated with data of participants, which causes a low degree of participation in the lottery.

As is known to all, the Merkle tree is a binary hash tree, and is a classical data verification algorithm. It can provide a proof with a size of 0(log₂n), thereby verifying whether a member is included in an n-element set. Therefore, in combination with the Merkle tree and a sorting manner, a novel verifiable lottery algorithm is provided.

### SUMMARY

In view of the above-mentioned technical problems in the prior art, the present disclosure provides a verifiable random lottery method based on a Merkle tree and a sorting manner. The present disclosure can realize subsequent verification on a lottery result, and fundamentally enhance fairness and persuasiveness of the lottery result. Specific technical solutions of the present disclosure are as follows:

A verifiable random lottery method based on a Merkle tree and a sorting manner includes the following steps:
step 1: determining a number of winners in a lottery and participants in the lottery;
step 2: allowing each of the participants to submit personal data;
step 3: allowing, at the beginning of the lottery, the participant to click and confirm a random timestamp;
step 4: allowing a lottery system to record the personal data and the random timestamp of each participant, constructing a Merkle tree with an SM3 algorithm, and taking a root of the Merkle tree as a random seed;
step 5: taking the random seed as an input, and iteratively running the SM3 algorithm to obtain a random string of the participant;
step 6: sorting all of the random strings in a descending manner;
step 7: selecting the winners in the lottery according to the given number of winners, and ending the lottery;
step 8: verifying the random seed of the lottery: allowing the participant to resubmit the personal data, and allowing the lottery system to verify a legality of the random seed with a membership certification function of the Merkle tree; and
step 9: verifying a lottery result: iteratively running the SM3 algorithm on a legal random seed to reproduce and verify the lottery result.

Further, the step 1 specifically includes:
step 1.1: determining the number of winners in the lottery, and labeling the number of winners as m; and
step 1.2: determining the participants in the lottery, and labeling the participants as P₀, . . . , Pₙ₋₁, a number of the participants being n, m≤n.

Further, the step 2 specifically includes: allowing the participant Pᵢ to submit the personal data Dᵢ to the lottery system, i=0, 1, . . . , n−1.

Further, the step 3 specifically includes:
step 3.1: setting a time period at the beginning of the lottery; and
step 3.2: allowing the participant to click a lottery confirmation through the lottery system in the time period, so as to determine the respective lottery timestamp tᵢ.

Further, the step 4 specifically includes:
step 4.1: allowing the lottery system to record the data Dᵢ and the random timestamp tᵢ of the participant;
step 4.2: calculating a number d=[log₂n] of layers of the Merkle tree, assuming h₁^{(d)}=SM3(Dᵢ∥t₁) for i=0,1, . . . , n−1, and assuming hᵢ^{(d)}=SM3(Dₙ₋₁∥tₙ₋₁) for i=n, n+1, . . . , 2^{d}−1, thereby obtaining hᵢ^{(d)} for 2^{d} leaf nodes of the Merkle tree; where on a dth layer, a hash merging operation hᵢ^{(d-1)}=SM3(h₂ᵢ^{(d)}∥h₂ᵢ₊₁^{(d)}) is performed on i=0,1, . . . , 2^{d-1}−1, ∥representing splicing on two pieces of data, thereby obtaining hᵢ^{(d-1)} for 2^{d-1} nodes on a (d−1)th layer; then on the (d−1)th layer, a hash merging operation hᵢ^{(d-2)}=SM3(h₂ᵢ^{(d-1)}∥h₂ᵢ₊₁^{(d-1)} is performed on i=0,1, . . . , 2^{d-2}−1, thereby obtaining hᵢ ^{(d-2)} for 2^{d-2} nodes on a (d−2)th layer; and the same operation is performed until a first layer, h₀⁽⁰⁾=SM3(h₀⁽¹⁾∥h₁⁽¹⁾) for the root of the Merkle tree is calculated, and all nodes of the Merkle tree are stored; and
step 4.3: taking the h₀⁽⁰⁾ for the root of the Merkle tree as the random seed, and disclosing the seed.

Further, the step 5 specifically includes:
step 5.1: calculating the random string r₀=SM3(seed) of the participant P₀ according to the random seed; and
step 5.2: iteratively calculating rᵢ₊₁=SM3(rᵢ) for i=0,1, . . . , n−1 to obtain the random strings for P₁, . . . , Pₙ₋₁.

Further, the step 6 specifically includes: sorting the random strings rᵢ corresponding to all of the participants Pᵢ in the descending manner according to corresponding binary values to obtain rₜ_{₀}>rₜ_{₁}>. . . >rₜ_{_{n−1}}, and disclosing a sorted result.

Further, the step 7 specifically includes: selecting the winners Pₜ_{₀}, Pₜ_{₁}, . . . , Pₜ_{_{m−1}} in the lottery according to the sorted result rₜ_{₀}>rₜ_{₁}>. . . >rₜ_{_{n−1}} of the random strings, and the number m of winners in the lottery.

Further, the step 8 specifically includes:
step 8.1: allowing the participant Pᵢ to resubmit the personal data Dᵢ and the random timestamp tᵢ to the lottery system;
step 8.2: allowing the lottery system to recalculate \tilde{h}ᵢ^{(d)}=SM3(Dᵢ∥t₁) for the leaf nodes, and provide a verification node sequence VN=[hₛ₍ᵢ₎^{(d)}, h_{s(f(i))}^{(d-1)}, h_{s(f(f(i)))}^{(d-2)}. . . h_{s(f}_{^{n−1}}₍ᵢ₎₎⁽¹⁾] from the \tilde{h}ᵢ^{(d)} to the root according to the stored Merkle tree, s(i)=i+(−1)ⁱ representing a sibling to a node i, and f(i)=[i/2] representing a father to the node i; and
step 8.3: executing a for circulation, and for j=d, d−1, . . . , 1,
calculating \tilde{h}_{f(i)}^{(j-1)}=SM3(conc(i, SM3(\tilde{h}ᵢ^{(j)}), SM3(h ₛ₍ᵢ₎^{(j)}))); and
updating i=f(i),
where, if i is an even number, conc(i, x, y)=x∥y; and if i is an odd number, conc(i, x, y)=y∥x; and
obtaining a recalculated \tilde{h}ₒ⁽⁰⁾ of the root upon completion of the circulation, and comparing the \tilde{h}₀⁽⁰⁾ with a previously disclosed random seed, where if the \tilde{h}₀⁽⁰⁾ and the previously disclosed random seed \tilde{h}₀⁽⁰⁾ are the same, the random seed in the lottery is legal and is successfully verified.

Further, the step 9 specifically includes:
step 9.1: recalculating a random string [symbol] =SM3(seed) of the participant P₀ according to a successfully verified random seed;
step 9.2: iteratively recalculating \tilde{r}ᵢ₊₁=SM3(\tilde{r}ᵢ) for i=0,1, . . . , n−1 to obtain random strings \tilde{r}₁, . . . , \tilde{r}ₙ₋₁ for P₁, . . . , Pₙ₋₁; and
step 9.3: sorting all of the random strings \tilde{r}ᵢ in the descending manner according to binary values to obtain a sorted sequence \tilde{r}ₜ_{₀}>\tilde{r}ₜ_{₁}> . . . >\tilde{r}ₜ_{_{n−1}}, and comparing the sorted sequence \tilde{r}ₜ_{₀}>\tilde{r}ₜ_{₁}> . . . >\tilde{r}ₜ_{_{n−1}} with the previously disclosed sorted sequence rₜ_{₀}>rₜ_{₁}> . . . >rₜ_{_{n−1}}, where if the sorted sequence \tilde{r}ₜ_{₀}>\tilde{r}ₜ_{₁}> . . . >\tilde{r}ₜ_{_{n−1}} and the previously disclosed sorted sequence rₜ_{₀}>rₜ_{₁}> . . . >rₜ_{_{n−1}} are completely the same, the lottery result is verified successfully.

The present disclosure achieves the following beneficial effects:

The present disclosure guarantees the randomness of the lottery content through the national cryptographic SM3 algorithm, and makes the lottery result verifiable through the Merkle tree. While ensuring fairness and security, the present disclosure provides a higher transparency and a verification mechanism, effectively solves the problems of a low degree of participation of users and a low transparency of the lottery result in existing lottery algorithms, and realizes a more reliable and credible lottery solution.

### BRIEF DESCRIPTION OF THE DRAWINGS

FIG. 1 schematically illustrates a main flowchart of a verifiable random lottery method based on a Merkle tree and a sorting manner according to the present disclosure.

### DETAILED DESCRIPTION OF THE EMBODIMENTS

To make the objectives, technical solutions, and advantages of the present disclosure clearer, the present disclosure is described in further detail below with reference to the drawings and embodiments.

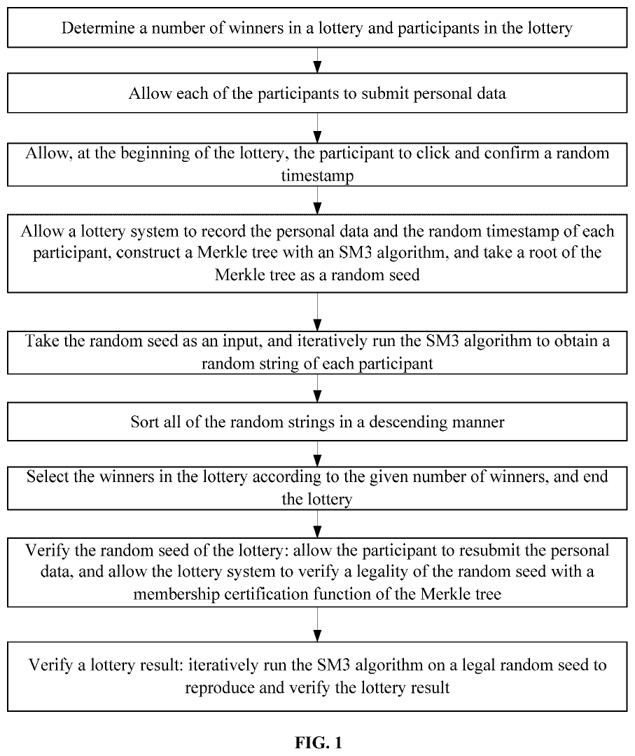

As shown in FIG. 1, the present disclosure provides a verifiable random lottery method based on a Merkle tree and a sorting manner, including the following steps:

Step 1: A number of winners in a lottery and participants in the lottery are determined.

Step 2: Each of the participants submits personal data.

Step 3: At the beginning of the lottery, the participant clicks and confirms a random timestamp.

Step 4: A lottery system records the personal data and the random timestamp of each participant, a Merkle tree is constructed with an SM3 algorithm, and a root of the Merkle tree is taken as a random seed.

Step 5: The random seed is taken as an input, and the SM3 algorithm is iteratively run to obtain a random string of the participant.

Step 6: All of the random strings are sorted in a descending manner.

Step 7: The winners in the lottery are selected according to the given number of winners, and the lottery is ended.

Step 8: The random seed of the lottery is verified: The participant resubmits the personal data, and the lottery system verifies a legality of the random seed with a membership certification function of the Merkle tree.

Step 9: A lottery result is verified: The SM3 algorithm is iteratively run on a legal random seed to reproduce and verify the lottery result.

The step 1 specifically includes:

Step 1.1: The number of winners in the lottery is determined, and labeled as m.

Step 1.2: The participants in the lottery are determined, and labeled as P₀, . . . , Pₙ₋₁, a number of the participants being n, m≤n.

The step 2 specifically includes: For i=0,1, . . . , n−1, the participant Pᵢ submits the personal data Dᵢ to the lottery system.

The step 3 specifically includes:

Step 3.1: A 1-h time period is set at the beginning of the lottery.

Step 3.2: The participant clicks a lottery confirmation through the lottery system in the time period, so as to determine the respective lottery timestamp tᵢ.

The step 4 specifically includes:

Step 4.1: The lottery system records the data Di and the random timestamp tᵢ of the participant.

Step 4.2: A number d=[log₂n] of layers of the Merkle tree is calculated, hᵢ^{(d)}=SM3(Dᵢ∥tᵢ) is assumed for i=0,1, . . . , n−1, and hᵢ^{(d)}=SM3(Dₙ₋₁∥tₙ₋₁) is assumed for i=n, n+1, . . . , 2^{d-1}, thereby obtaining hᵢ^{(d)} for 2^{d} leaf nodes of the Merkle tree. On a dth layer, for i=0,1, . . . , 2^{d-1}−1, a hash merging operation h₁^{(d-1)}=SM3(h₂ᵢ^{(d)}∥h₂ᵢ₊₁^{(d)}) is performed, ∥ representing splicing on two pieces of data, thereby obtaining h₁^{(d-1)} for 2^{d-1} nodes on a (d−1)th layer. On the (d−1)th layer, for i=0,1, . . . ,2^{d-2}−1, a hash merging operation hᵢ^{(d-2)}=SM3(h₂ᵢ^{(d-1)}∥h₂ᵢ₊₁^{(d-1)} is performed, thereby obtaining hᵢ^{(d-2)} for 2^{d-2} nodes on a (d−2)th layer. The same operation is performed until a first layer, h₀⁽⁰⁾=SM3(h₀⁽¹⁾∥h₁⁽¹⁾) for the root of the Merkle tree is calculated, and all nodes of the Merkle tree are stored.

Step 4.3: The h₀⁽⁰⁾ for the root of the Merkle tree is taken as the random seed, and the seed is disclosed.

The step 5 specifically includes:

Step 5.1: The random string r₀=SM3(seed) of the participant P₀ is calculated according to the random seed.

Step 5.2: rᵢ₊₁=SM3(rᵢ) is iteratively calculated for i=0,1, . . . , n−1 to obtain the random strings for P₁, . . . , Pₙ₋₁.

Further, the step 6 specifically includes: The random strings r₁ corresponding to all of the participants Pᵢ are sorted in a descending manner according to corresponding binary values to obtain rₜ_{₀}>rₜ_{₁}> . . . >rₜ_{_{n−1}}, and a sorted result is disclosed.

Further, the step 7 specifically includes: The winners Pₜ_{₀}, Pₜ_{₁}, . . . , Pₜ_{_{m−1}} in the lottery are selected according to the sorted result rₜ_{₀}>rₜ_{₁}> . . . >rₜ_{_{m−1}}, of the random strings, and the number m of winners in the lottery.

The step 8 specifically includes:

Step 8.1: The participant Pᵢ resubmits the data Dᵢ and the random timestamp tᵢ to the lottery system.

Step 8.2: The lottery system recalculates \tilde{h}₁^{(d)}=SM3(Dᵢ∥t₁) for the leaf nodes, and provides a verification node sequence VN=[hₛ₍ᵢ₎^{(d)}, h_{s(f(i))}^{(d-1)}, h_{s(f(f(i)))}^{(d-2)}, . . . h_{s(f}_{^{n−1}}₍ᵢ₎₎⁽¹⁾] from the \tilde{h}ᵢ^{(d)} to the root according to the stored Merkle tree, s(i)=i+(−1)ⁱ representing a sibling to the node i, and f(i)=[i/2] representing a father to the node i.

Step 8.3: A for circulation is calculated. For j=d, d−1, . . . , 1:

\tilde{h}_{f(i)}^{(j-1)}=SM3(conc(i, SM3(\tilde{h}ᵢ^{(j)}), SM3(hₛ₍ᵢ₎^{(j)}))) is calculated.

i=f(i) is updated.

If i is an even number, conc(i, x, y)=x∥y. If i is an odd number, where conc(i, x, y)=y∥x. conc represents splicing.

A recalculated \tilde{h}₀⁽⁰⁾ of the root is obtained upon completion of the circulation, and the \tilde{h}₀⁽⁰⁾ is compared with a previously disclosed random seed. If the \tilde{h}₀⁽⁰⁾ and the previously disclosed random seed are the same, the random seed in the lottery is legal and is successfully verified.

The step 9 specifically includes:

Step 9.1: A random string \tilde{r}₀=SM3(seed) of the participant P₀ is recalculated according to a successfully verified random seed.

Step 9.2: \tilde{r}ᵢ₊₁=SM3(\tilde{r}ᵢ) is iteratively recalculated for i=0,1, . . . , n−1 to obtain random strings \tilde{r}₁, . . . , \tilde{r}ₙ₋₁ for P₁, . . . , Pₙ₋₁

Step 9.3: All of the random strings \tilde{r}ᵢ are sorted in the descending manner according to binary values to obtain a sorted sequence \tilde{r}ₜ_{₀}>\tilde{r}ₜ_{₁}> . . . >\tilde{r}ₜ_{_{n−1}}, and the sorted sequence \tilde{r}ₜ_{₀}>\tilde{r}ₜ_{₁}> . . . >\tilde{r}ₜ_{_{n−1}} is compared with the previously disclosed sorted sequence rₜ_{₀}>rₜ_{₁}> . . . >rₜ_{_{n−1}}. If the sorted sequence \tilde{r}ₜ_{₀}>\tilde{r}ₜ_{₁}> . . . >\tilde{r}ₜ₋₁ and the previously disclosed sorted sequence rₜ_{₀}>rₜ_{₁}> . . . >rₜ_{_{n−1}} are completely the same, the lottery result is verified successfully.

In order to better understand the details of the present disclosure, a specific implementation example for the verifiable random lottery method based on a Merkle tree and a sorting manner is provided below. Due to limitations in data size, the following descriptions are made to a case including eight participants and three winners. A Faker library of python is used to simulate and construct random user data, specifically:
(1) User data:
ID: 0001 Name: Liao Jun ID number: 3301XXXXXXXXXXXX45 Timestamp: 1421975140. ID: 0002 Name: Wang Juan ID number: 3301XXXXXXXXXXXX79 Timestamp: 883630529.
ID: 0003 Name: Xin Gang ID number: 3301XXXXXXXXXXXX28 Timestamp: 1059085504. ID: 0004 Name: Yang Na ID number: 3301XXXXXXXXXXXX10 Timestamp: 655185617.
ID: 0005 Name: Le Qian ID number: 3301XXXXXXXXXXXX29 Timestamp: 481534905.
ID: 0006 Name: Zhang Cheng ID number: 3301XXXXXXXXXXXX62 Timestamp: 1341518705. ID: 0007 Name: Nie Ling ID number: 3301XXXXXXXXXXXX29 Timestamp: 492833261. ID: 0008 Name: Song Guirong ID number: 3301XXXXXXXXXXXX28 Timestamp: 1213306144.

A Merkle tree with eight leaf nodes and three layers is constructed. Data of the leaf nodes on the third layer is as follows:

[h₀⁽³⁾, h₁⁽³⁾, h₂⁽³⁾, h₃⁽³⁾, h₄⁽³⁾, h₅⁽³⁾, h₆⁽³⁾, h₇⁽³⁾]=[4e2459a9418948a071b94594df64d3526a0cbfce6e4c30283d387e417d871ae6, 907a03f009cc911e8f959e264fbccb69aeea18d6c8405ealecd63ed3d6395a0b, 454285e96ae19dd91beca9fb2909888c07dbf58cb7c1c48597d9dacda777fdb3, c75e7aafa53cf03c26d398d2c1884e8b94769f9db74f72fb0f2ee6d22993d17c, 8bf8b1391e44e3553d514ca5c6ab89cb73125911046f76a5b80df1160e2fe610, a19a4d406dbf7bd86327c9f196eedd9c5cdb8bb17c63028193612247dbf9bd9d, 65e068clfe56c52593e87a70e2a8836d4ecd4ef7a3ca973b2824f891d534fd83, f0a256d28ac64630f4185c6bc8d2a4f7feb3bfaa3be49913d4ef5ac32f03c62c].

Through hash merging, data of the nodes on the second layer is as follows:

[h₀⁽²⁾, h₁⁽²⁾, h₂⁽²⁾, h₃⁽²⁾]=[08437ce83085caa2034b12c4d3fb573f0013c598533992ef9bf06441a0e3f7bc, 7ffb37d2e06d01d43a8207c72b19bac96eabac363d17d7ca895b091ec6f57d14, 86e8756dd63267bc8fe72c4ad92768858fbf3ffa2d4ff69ac3f3f1df5374ee3a, b1afe1db8d544e24c6121d2cc359d2b256a7cce92456d5fddd0b6eb53640c97b].

Through the hash merging, data of the nodes on the second layer is as follows:

[h₀⁽¹⁾, h₁⁽¹⁾]=[a1fb50a4d0c64341e037789c513e15ae3238bf69845b8bf82e32a65f1745277f, a596f45cb2b2fceafdcedadc6628ed6659aaf2166bd5dd36ca5cceee522bb0cf].

Through the hash merging, a root obtained is taken as an initial seed, and the result is as follows:

h₀⁽⁰⁾=3d2780bc197dec49b4e74dc60b804d00c53e0ff5f4fa9d03705f9dc081cdbe9d.
(2) An SM3 algorithm is run with the initial seed in (1) to obtain r₀=SM3(seed). For i=0,1, . . . , n−1, rᵢ₊₁=SM3(rᵢ) is iteratively calculated to obtain respective random strings of the eight participants.

Liao Jun:

3f1927472dd70dc678cadcef096a58d004d4cd5919cdb7c5c82aa9c4a2305578.

Wang Juan:

3c32f908242e2eb8ad6ea3accd327535c9ec12b7dd7d98fdbeea18f7905871c7.

Xin Gang:

eb0991f12a3b7f5737d9f0dabc3fd0dd69933d993346b4c2faf87cbbe46aa3f3.

Yang Na:

a815cfb79e2bc5f75d8c8b99cd01e5e4f6328170d42ce63aabc6e3ea95969b53.

Le Qian:

cb97e8236838aa361671a6167611b7b543fa5a81b19f1950cd12a77568fda02e.

Zhang Cheng:

e83de8ad84b65b54650b5d8b55eb1eb8e0e424aaff42f70582e84a7c98102285.

Nie Ling:

71845c8317dccd3789ee99d0b5e640bbb91e46cd28f9400e9c94fe2029ad9a6f.

Song Guirong:

34d7228e9a7dc07c4a87849ce6718e423e4b35b609d538dc40f7d6e0d4508c82.
(3) The eight random strings are sorted in a descending manner to a sorted sequence of the users:

Xin Gang>Zhang Cheng>Le Qian>Yang Na>Nie Ling>Liao Jun>Wang Juan>Song Guirong.

The three winners are Xin Gang, Zhang Cheng and Le Qian.
(4) The user data is reused. With membership certification of the Merkle tree, a legality of the initial seed is verified. For example, for the winner Xin Gang, a hash value of the user data in SM3 is \tilde{h}₂⁽³⁾=SM3(D₂∥t₂)=454285e96ae19dd91beca9fb2909888c07dbf58cb7c1c48597d9dacda777fdb3.

A lottery server can provide a verification node sequence VN=[h₃⁽³⁾, h₀⁽²⁾, h₁⁽¹⁾]=[c75e7aafa53cf03c26d398d2c1884e8b94769f9db74f72fb0f2ee6d22993d17c, 08437ce83085caa2034b12c4d3fb573f0013c598533992ef9bf06441a0e3f7bc, a596f45cb2b2fceafdcedadc6628ed6659aaf2166bd5dd36ca5cceee522bb0cf].

Three steps are performed for calculation: \tilde{h}₁⁽²⁾=SM3(\tilde{h}₂⁽³⁾∥h₂⁽³⁾), \tilde{h}₀⁽¹⁾=SM3(h₀⁽²⁾∥\tilde{h}₁⁽²⁾), \tilde{h}₀⁽⁰⁾=SM3(h₀⁽¹⁾∥\tilde{h}₀⁽¹⁾),
thereby obtaining:

\tilde{h}₀⁽⁰⁾=3d2780bc197dec49b4e74dc60b804d00c53e0ff5f4fa9d03705f9dc081cdbe9d.

The seed is the same as the initial seed calculated in (2), and is successfully verified.
(5) The SM3 algorithm is iteratively run with the seed in (4) to reproduce the random strings of all people:

Liao Jun:

3f1927472dd70dc678cadcef096a58d004d4cd5919cdb7c5c82aa9c4a2305578.

Wang Juan:

3c32f908242e2eb8ad6ea3accd327535c9ec12b7dd7d98fdbeea18f7905871c7.

Xin Gang:

eb0991f12a3b7f5737d9f0dabc3fd0dd69933d993346b4c2faf87cbbe46aa3f3.

Yang Na:

a815cfb79e2bc5f75d8c8b99cd01e5e4f6328170d42ce63aabc6e3ea95969b53.

Le Qian:

cb97e8236838aa361671a6167611b7b543fa5a81b19f1950cd12a77568fda02e.

Zhang Cheng:

e83de8ad84b65b54650b5d8b55eb1eb8e0e424aaff42f70582e84a7c98102285.

Nie Ling:

71845c8317dccd3789ee99d0b5e640bbb91e46cd28f9400e9c94fe2029ad9a6f.

Song Guirong:

34d7228e9a7dc07c4a87849ce6718e423e4b35b609d538dc40f7d6e0d4508c82.

The result is the same as that calculated in (3), and the sorted result is also the same. That is, the winners are Xin Gang, Zhang Cheng and Le Qian, and the result is verified successfully.

In conclusion, the present disclosure generates the structure of the Merkle tree based on the SM3 algorithm through submitted data and respective confirmed random timestamps of the participants in the lottery, takes a root of the Merkle tree as a random seed, takes the random seed as an input, iteratively runs the SM3 algorithm to obtain random strings of the participants, and sorts the random strings, thereby determining the winners in the lottery. If there is a need to verify a lottery result, the participant resubmits the data, and verifies a legality of the random seed with membership certification of the Merkle tree. By taking the random seed as the input, random strings of all participants are further generated to verify the lottery result.

By combining the initial seed with the user data, the present disclosure enhances a degree of participation of the users in the lottery. With the verifiable mechanism, the present disclosure can verify the lottery result subsequently compared with the existing random lottery solution. The classical random lottery solution is based on a software-implemented pseudo-random number generator, and the seed is selected depending on an internal real-time state parameter of a computer or a ball lottery machine and cannot be reproduced and verified. With the verifiable mechanism, the present disclosure generates the random seed depending on data and selected random timestamps of the participants. With the structure of the Merkle tree, after all hash values of the Merkle tree are recorded, the random seed and the final lottery result can be verified. That is, the participant can provide information subsequently to verify the lottery result and the process. The present disclosure makes the result more transparent and credible, and makes the lottery result more persuasive.

The above described are merely preferred implementations of the present disclosure rather than limitations to the present disclosure in any form. Although the implementation process of the present disclosure is described in detail with reference to the foregoing embodiments, those skilled in the art can still make modifications to the technical solutions described in the foregoing embodiments, or make equivalent replacement to some of the technical features. Any modifications and equivalent substitutions made within the spirit and principle of the present disclosure should be included within the protection scope of the present disclosure.

What is claimed is:

1. A verifiable random lottery method based on a Merkle tree and a sorting manner, comprising the following steps:
step 1: determining a number of winners in a lottery and participants in the lottery;
step 2: allowing each of the participants to submit personal data;
step 3: allowing, at the beginning of the lottery, the participant to click and confirm a random timestamp;
step 4: allowing a lottery system to record the personal data and the random timestamp of each participant, constructing a Merkle tree with an SM3 algorithm, and taking a root of the Merkle tree as a random seed;
step 5: taking the random seed as an input, and iteratively running the SM3 algorithm to obtain a random string of the participant;
step 6: sorting all of the random strings in a descending manner;
step 7: selecting the winners in the lottery according to the given number of winners, and ending the lottery;
step 8: verifying the random seed of the lottery: allowing the participant to resubmit the personal data, and allowing the lottery system to verify a legality of the random seed with a membership certification function of the Merkle tree; and
step 9: verifying a lottery result: iteratively running the SM3 algorithm on a legal random seed to reproduce and verify the lottery result.

2. The verifiable random lottery method based on a Merkle tree and a sorting manner according to claim 1, wherein the step 1 specifically comprises:
step 1.1: determining the number of winners in the lottery, and labeling the number of winners as m; and
step 1.2: determining the participants in the lottery, and labeling the participants as P₀, . . . , Pₙ₋₁, a number of the participants being n, m≤n.

3. The verifiable random lottery method based on a Merkle tree and a sorting manner according to claim 2, wherein the step 2 specifically comprises: allowing the participant Pᵢ to submit the personal data Dᵢ to the lottery system, i=0,1, . . . , n−1.

4. The verifiable random lottery method based on a Merkle tree and a sorting manner according to claim 3, wherein the step 3 specifically comprises:
step 3.1: setting a time period at the beginning of the lottery; and
step 3.2: allowing the participant to click a lottery confirmation through the lottery system in the time period, so as to determine the respective lottery timestamp tᵢ.

5. The verifiable random lottery method based on a Merkle tree and a sorting manner according to claim 4, wherein the step 4 specifically comprises:
step 4.1: allowing the lottery system to record the data Di and the random timestamp tᵢ of the participant;
step 4.2: calculating a number d=[log₂n] of layers of the Merkle tree, assuming hᵢ^{(d)}=SM3(Dᵢ∥tᵢ) for i=0,1, . . . , n−1, and assuming hᵢ^{(d)}=SM3(Dₙ₋₁∥tₙ₋₁) for i=n, n+1, . . . , 2^{d}−1, thereby obtaining hᵢ^{(d)} for 2^{d} leaf nodes of the Merkle tree, wherein on a dth layer, a hash merging operation hᵢ^{(d)}=SM3(h₂ᵢ^{(d)}∥h₂ᵢ₊₁^{(d)}) is performed on i=0,1, . . . , 2^{d-1}−1, ∥ representing splicing on two pieces of data, thereby obtaining hᵢ^{(d-1)} for 2^{d-1} nodes on a (d−1)th layer; then on the (d−1)th layer, a hash merging operation hᵢ^{(d-2)}=SM3h₂ᵢ^{(d-1)}∥h₂ᵢ₊₁^{(d-1)}) is performed on i=0,1, . . . , 2^{d-2}31 1, thereby obtaining hᵢ^{(d-2)} for 2^{d-2} nodes on a (d−2)th layer; and the same operation is performed until a first layer, h₀⁽⁰⁾=SM3(h₀⁽¹⁾∥h₁⁽¹⁾) for the root of the Merkle tree is calculated, and all nodes of the Merkle tree are stored; and
step 4.3: taking the h₀⁽⁰⁾ for the root of the Merkle tree as the random seed, and disclosing the seed.

6. The verifiable random lottery method based on a Merkle tree and a sorting manner according to claim 5, wherein the step 5 specifically comprises:
step 5.1: calculating the random string r₀=SM3(seed) of the participant P₀ according to the random seed; and
step 5.2: iteratively calculating rᵢ₊₁=SM3(rᵢ) for i=0,1, . . . , n−1 to obtain the random strings for P₁, . . . , Pₙ₋₁.

7. The verifiable random lottery method based on a Merkle tree and a sorting manner according to claim 6, wherein the step 6 specifically comprises: sorting the random strings rᵢ corresponding to all of the participants Pᵢ in the descending manner according to corresponding binary values to obtain rₜ_{₀}>rₜ_{₁}> . . . >rₜ_{_{n−1}}, and disclosing a sorted result.

8. The verifiable random lottery method based on a Merkle tree and a sorting manner according to claim 7, wherein the step 7 specifically comprises: selecting the winners Pₜ_{₀}, Pₜ_{₁}, . . . , Pₜ_{_{m−1}} in the lottery according to the sorted result rₜ_{₀}>rₜ_{₁}> . . . >rₜ_{_{n−1}} of the random strings, and the number m of winners in the lottery.

9. The verifiable random lottery method based on a Merkle tree and a sorting manner according to claim 8, wherein the step 8 specifically comprises:
step 8.1: allowing the participant Pᵢ to resubmit the personal data Dᵢ and the random timestamp tᵢ to the lottery system;
step 8.2: allowing the lottery system to recalculate \tilde{h}ᵢ^{(d)}=SM3(Dᵢ∥tᵢ) for the leaf nodes, and provide a verification node sequence VN=[hₛ₍ᵢ₎^{(d)}, h_{s(f(i))}^{(d-2)}, . . . h_{s(f}_{^{n−1}}₍ᵢ₎₎⁽¹⁾] from the \tilde{h}ᵢ^{(d)} to the root according to the stored Merkle tree, s(i)=i+(−1)ⁱ representing a sibling to a node i, and f(i)=[i/2] representing a father to the node i; and
step 8.3: executing a for circulation, and for j=d, d−1, . . . , 1,
calculating \tilde{h}_{f(i)}^{(j-1)}=SM3(conc(i, SM3(\tilde{h}ₛ₍ᵢ₎^{(j)}))), and
updating i=f(i),
wherein if i is an even number, conc(i, x, y)=x∥y; and if i is an odd number, conc(i, x, y)=y∥x, conc representing splicing; and
obtaining a recalculated \tilde{h}₀⁽⁰⁾ of the root upon completion of the circulation, and comparing the \tilde{h}₀⁽⁰⁾ with a previously disclosed random seed, wherein if the \tilde{h}₀⁽⁰⁾ and the previously disclosed random seed are the same, the random seed in the lottery is legal and is successfully verified.

10. The verifiable random lottery method based on a Merkle tree and a sorting manner according to claim 9, wherein the step 9 specifically comprises:
step 9.1: recalculating a random string \tilde{r}₀=SM3(seed) of the participant P₀ according to a successfully verified random seed;
step 9.2: iteratively recalculating \tilde{r}ᵢ₊₁=SM3(\tilde{r}ᵢ) for i=0,1, . . . , n−1 to obtain random strings \tilde{r}₁, . . . , \tilde{r}ₙ₋₁ for P₁, . . . , Pₙ₋₁; and
step 9.3: sorting all of the random strings \tilde{r}ᵢ in the descending manner according to binary values to obtain a sorted sequence \tilde{r}ₜ_{₀}>\tilde{r}ₜ_{₁}> . . . \tilde{r}ₜ_{_{n−1}}, and comparing the sorted sequence \tilde{r}ₜ_{₀}>\tilde{r}ₜ_{₁}> . . . \tilde{r}ₙ₋₁ with the previously disclosed sorted sequence rₜ_{₀}>rₜ_{₁}> . . . >rₜ_{_{n−1}}, wherein if the sorted sequence \tilde{r}ₜ_{₀}>\tilde{r}ₜ_{₁}> . . . >\tilde{r}ₜ_{_{n−1}} and the previously disclosed sorted sequence rₜ_{₀}>rₜ_{₁}> . . . >rₜ_{_{n−1}}, are completely the same, the lottery result is verified successfully.
